(19) United States
(12) Patent Application Publication
(10) Pub. No.: US 2004/0148437 A1
(43) Pub. Date: Jul. 29, 2004

(54) Synchronous network establishing method and apparatus

(76) Inventor: Koji Tanonaka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/719,282

(22) Filed: Nov. 20, 2003

(30) Foreign Application Priority Data
Dec. 12, 2002 (JP) 2002-380827

(51) Int. Cl. G06F 15/16

(52) U.S. Cl. 709/246

(57) ABSTRACT

A method of establishing synchronization in a network including a node apparatus conforming to a first scheme and a node apparatus conforming to a second scheme is disclosed. The first scheme and the second scheme implement different synchronous state indication codes for establishing the synchronous network. By converting a synchronous state indication code from a node apparatus conforming to one scheme into a synchronous state indication code suitable for a neighboring node apparatus conforming to the other scheme, a node apparatus conforming to one of the schemes can be cascaded into a network conforming to the other scheme, and network synchronization can be established.

### BACKGROUND OF THE INVENTION

1. Field of the Invention

The present invention relates generally to a synchronous network establishing method and apparatus, and particularly to a synchronous network establishing method and apparatus for establishing synchronization between a SONET apparatus and an SDH apparatus.

2. Description of the Related Art

In a network conforming to SDH (Synchronous Digital Hierarchy) or SONET (Synchronous Optical Network), it is very important to have network synchronization established at all times. Therefore, in an SDH or SONET network, measures are taken to ensure that network synchronization is not interrupted due to a disorder in a master clock or a disorder in a line transmitting the synchronization, for example.

FIG. 1 shows a basic configuration of a conventional SDH network. As is shown in this drawing, usually, two master clocks P and S acting as primary and secondary reference clocks, respectively, are implemented in the SDH network. This arrangement is made in order to provide redundancy to the master clock of the network. The SDH network also includes interconnected nodes NE 1˜4. A node (NE: Network Element) to which an output from the master clock is directly input is referred to as a GNE (General Network Element) of the synchronous network.

In FIG. 1, the node NE 1 corresponds to the GNE. Each of the nodes NE 1˜4 has a function of selecting a timing source for realizing synchronization with the master clock. Normally, the timing source selecting function of each of the nodes NE 1˜4 is able to select a plurality of timing sources, and prioritize the selected timing sources.

The qualities of the prioritized timing sources are constantly monitored, and the timing source with the highest quality is selected. If more than one of the timing sources have the same quality, the timing source with the higher priority is selected. Also, when the quality of the timing source currently selected is degraded, the timing source is automatically switched to the timing source having the second highest quality.

For the transmission of the qualities of the timing sources, when a transmission path of STM-n (Synchronous Transfer Module Level-n) is used, an SSM (Synchronization Status Message) code is attached to the low-order four bits of an S1 byte contained in a MSOH (Multiplex Section Over Head).

In FIG. 1, the node NE 1 corresponding to the GNE of the synchronous network selects an external clock input A provided from the master clock P (primary master clock) as the timing source with priority 1 (first priority). Also, the node NE 1 selects a transmission path G as the timing source with priority 2 (second priority) so that when the quality of the external clock input A from the master clock P is degraded, the NE 1 is able to acquire a clock in sync with the master clock S (secondary master clock).

The node NE 2 selects a transmission path B as the timing source with priority 1 to acquire a clock in sync with the master clock P from the node NE 1. Also, the node NE 2 selects a transmission path F as the timing signal with priority 2 to acquire a clock in sync with the master clock S in case the quality of the transmission path B is degraded. The node NE 3 selects a transmission path C as the timing source with priority 1 to acquire a clock in sync with the master clock P from the node NE 2. Also, the node NE 3 selects a transmission path E as the timing source with priority 2 to acquire a clock in sync with the master clock Sin case the quality of the transmission path C is degraded.

The node NE 4 selects a transmission path D as the timing source with priority 1 to acquire a clock in sync with the master clock P. Also, the node NE 4 selects an external input H from the master clock S as the timing source with priority 2 to acquire a clock in sync with the master clock S in case the quality of the transmission path D is degraded.

FIG. 2 shows a state of the synchronous network of FIG. 1 in a case where the quality of the master clock P is degraded and the timing source for each of the nodes NE 1˜4 is switched. As is shown in the drawing, the nodes NE 1, NE 2, NE 3, and NE 4 select the transmission paths G, F, E, H with priority 2 as their respective timing sources.

FIG. 3 shows a state of the synchronous network of FIG. 1 in a case where the transmission path C is degraded and the timing sources for the nodes NE 3 and NE 4 are switched. As is shown in the drawing, the node NE 3 selects the transmission path E with priority 2 as its timing source and the node NE 4 selects the external clock input H with priority 2 as its timing source.

In recent years and continuing, the so-called global carriers are becoming the service providers to a majority of clients worldwide, and networks covering a plurality of countries are increasing (e.g., see Japanese Patent Gazette No.3003948). As a consequence, an SDH node apparatus (SDH apparatus) and a SONET node apparatus (SONET apparatus) are more likely to reside in the same network. Current node apparatuses are designed with due consideration for such cases in which both the SDH and SONET apparatuses reside within a network. Thereby, a main signal or an alarm can be detected without complications.

However, with respect to synchronization, problems are generated since the definitions of the SSM codes for the SDH apparatus and SONET apparatus are different.

FIG. 4 shows the definitions of the SSM codes for SDH and SONET.

Conventionally, a synchronous network cannot be realized with the SDH and SONET using the SSM codes, and instead, an SSM disable function or an assumed SSM function is used.

FIG. 5A is a diagram illustrating the SSM disable function, and FIG. 5B is a diagram illustrating the assumed SSM function. The SSM disable function is a function for detecting a downfall of the timing source and switching the timing source without using the SSM code. The assumed SSM function is a function for rewriting a received SSM code into a given SSM value (fixed value).

FIG. 6 illustrates a case in which a SONET apparatus resides within the SDH network of FIG. 1. In this drawing, the nodes NE 1, NE 2, and NE 4 correspond to SDH apparatuses, and the node NE 3 corresponds to a SONET apparatus. The node NE 1 determines the SSM code from the external clock input A to be ‘0010’, which corresponds to QL-PRC (Primary Reference Clock) according to the-definitions of the SSM codes for SDH shown in FIG. 4, and determines the SSM code sent from the transmission path G to be ‘1111’, which corresponds to QL-DNU (Not to be Used for Synchronization) Based on this determination, the node NE 1 selects the timing source of priority 1 with the higher quality (external clock input A).

The node NE 2 determines the SSM code sent from the transmission path B to be ‘0010’, which corresponds to QL-PRC (Primary Reference Clock) and the SSM code sent from the transmission path F to be ‘1100’, which corresponds to QL-INV12 (Invalid), and selects the timing source of priority 1 with the higher quality (transmission path B). The node NE 3 determines the SSM code sent from the transmission path C to be ‘0010’, which corresponds to QL-INV2 (Invalid) according to the definitions of the SSM codes for SONET shown in FIG. 4, determines the SSM code sent from the transmission path E to also be ‘0010’, which corresponds to QL-INV2 (Invalid), and thereby determines that no valid timing sources are available and an internal clock or a hold over has to be used.

The node NE 4 determines the SSM code sent from the transmission path D to be ‘1100’, which corresponds to QL-INV12 (Invalid) and the SSM code from the external clock input H to be ‘0010’, which corresponds to QL-PRC (Primary Reference Clock), and selects the timing source of priority 2 with the higher quality (external clock input H). In the above example, proper cascade connection of the SONET apparatus to the SDH network cannot be realized due to the differences in the definitions of the SSM codes in SONET and SDH. The same holds true for an SDH apparatus residing in a SONET network.

### SUMMARY OF THE INVENTION

The present invention has been conceived in response to the above described problems of the related art and its object is to provide a synchronous network establishing method and apparatus for establishing network synchronization by realizing cascade connection of a node apparatus conforming to one of a first scheme or a second scheme to a network conforming to the other one of the first scheme or the second-scheme.

A synchronous network establishing method of the present invention relates to a method of establishing a synchronous network in which a node apparatus conforming to a first scheme and a node apparatus conforming to a second scheme co-reside, wherein the first scheme and the second scheme implement different synchronous state indication codes for establishing the synchronous network, the method including the step of:

converting a first synchronous state indication code that is supplied from the node apparatus conforming to one of the first scheme and the second scheme into a second synchronization state indication code for the node apparatus conforming to the other one of the first scheme and the second scheme.

The synchronous network establishing method of the present invention may further include the step of including the first synchronous state indication code that is supplied from the node apparatus conforming to one of the first scheme and the second scheme in an empty bit of the converted second synchronous state indication code.

The synchronous network establishing method of the present invention may further include the step of using a pre-converted synchronous state indication code included in an empty bit of the first synchronous state indication code supplied from the node apparatus conforming to one of the first scheme and the second scheme.

An apparatus of the present invention for establishing a synchronous network relates to a node apparatus conforming to one of a first scheme and a second scheme that is connected to a counterpart node apparatus conforming to the other one of the first scheme and the second scheme, wherein the first scheme and the second scheme implement different synchronous state indication codes for-establishing a synchronous network, the node apparatus including:

a synchronous state indication code converting unit for converting the synchronous state indication code supplied from the counterpart node apparatus into the other synchronous state indication code for the node apparatus conforming to one of the first scheme and the second scheme.

The node apparatus of the present invention may further include a selecting unit for selecting one of the synchronous state indication code supplied from the counterpart node and the converted synchronous state indication code obtained by the synchronous state indication code converting unit.

The selecting unit of the present invention may administer switching according to a switching instruction signal.

The node apparatus of the present invention may further include a switch unit for instructing a switching of the selecting unit.

The node apparatus of the present invention may alternatively include a switching instruction unit for detecting a predetermined bit of a signal supplied from the counterpart node apparatus to determine which of the first scheme and the second scheme the counterpart node apparatus conforms to, and instructing a switching of the selecting unit based on the determination.

Further, a content to be converted by the synchronous state indication code converting unit of the present invention may be arbitrarily changed.

It is noted that the first scheme and the second scheme implemented in the present invention may correspond to the SDH and SONET, for example, the synchronous state indication code converting unit of the present invention may correspond to an SDH/SONET converting unit, the selecting unit of the present invention to an S1 selecting unit, the switch unit of the present invention to a dip switch, and the switching instruction unit of the present invention to a CI detecting unit, for example.

### BRIEF DESCRIPTION OF THE DRAWINGS

FIG. 1 is a schematic diagram showing a basic configuration of a conventional SDH network;

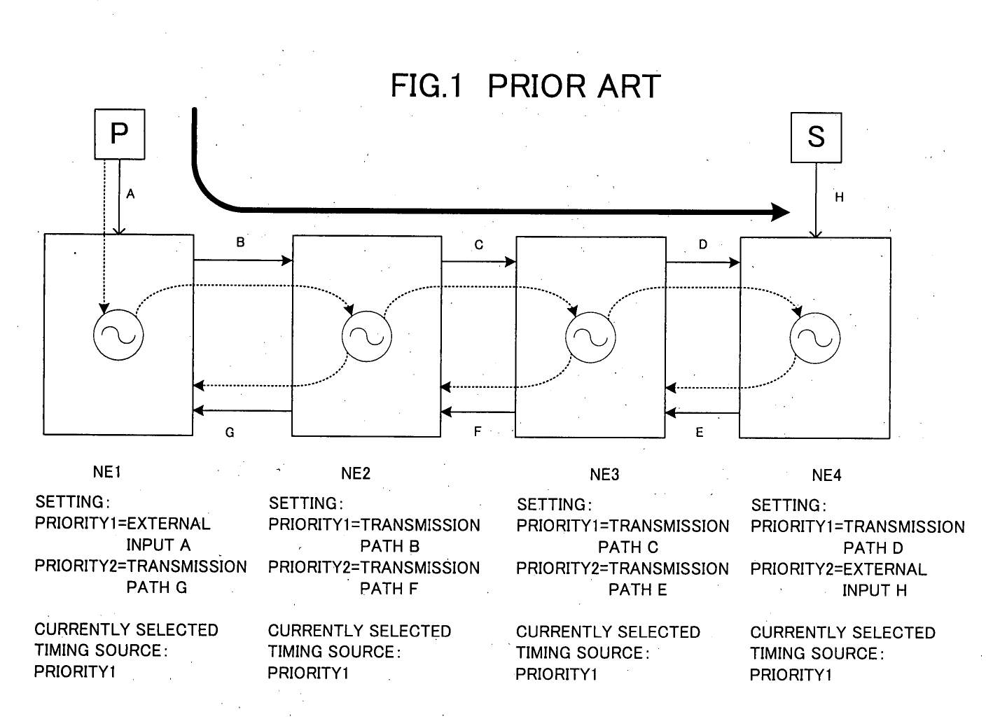

FIG. 2 shows a state of the SDH network of FIG. 1 being in sync with a secondary master clock;

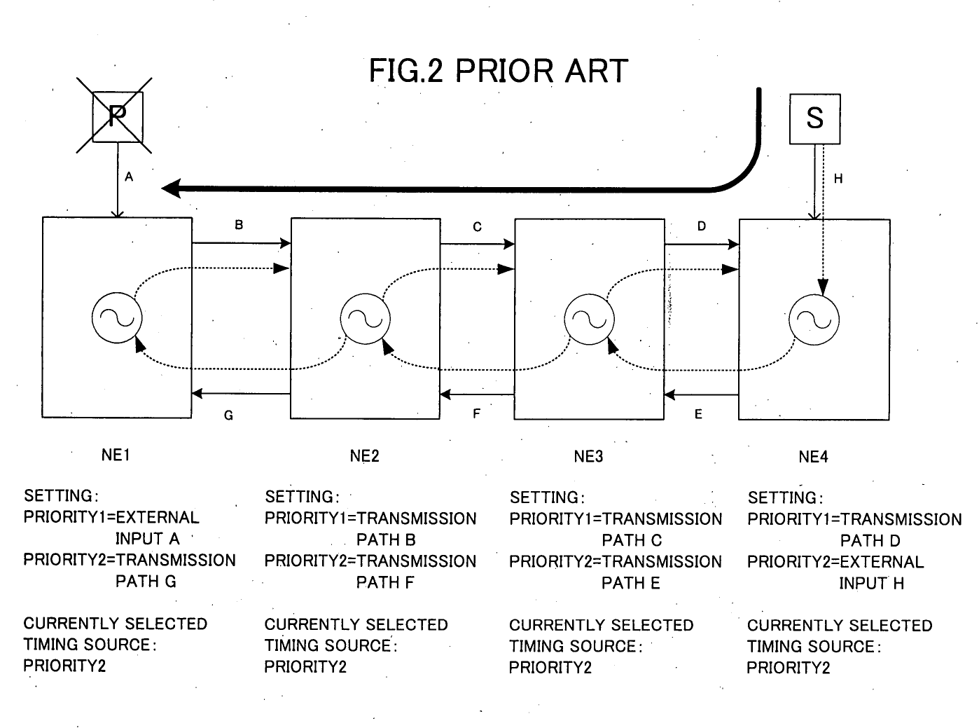

FIG. 3 shows a state of the SDH network of FIG. 1 in a case where the quality of a transmission path is degraded so that switching of a timing source takes place;

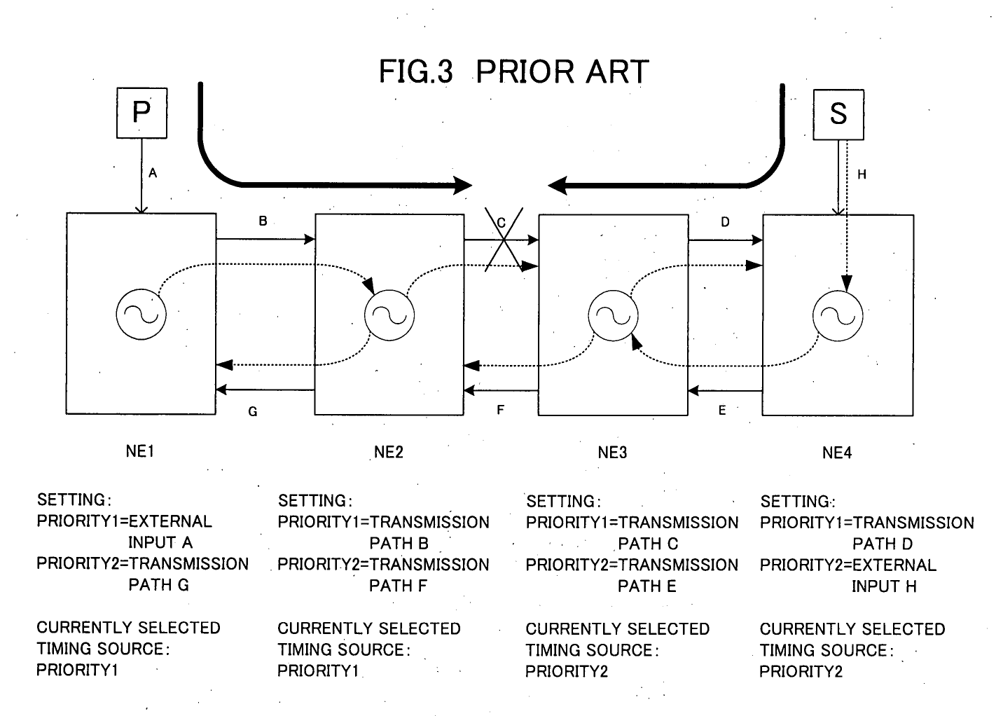

FIG. 4 is a table showing definitions of SSM codes according to SDH and SONET;

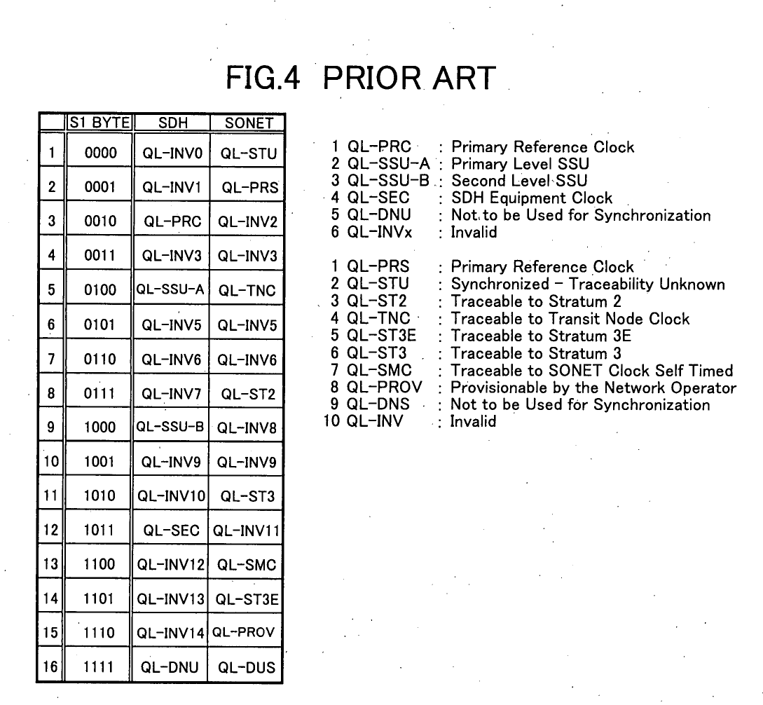

FIGS. 5A and 5B are schematic diagrams respectively illustrating an SSM disable function and an assumed SSM function;

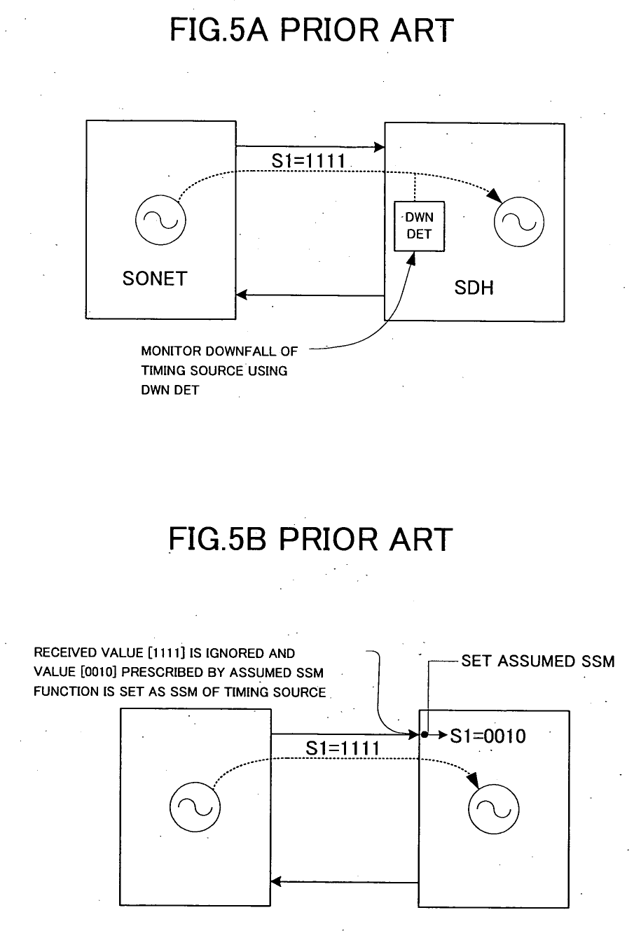

FIG. 6 is a schematic diagram illustrating a case where a SONET apparatus resides in the SDH network of FIG. 1;

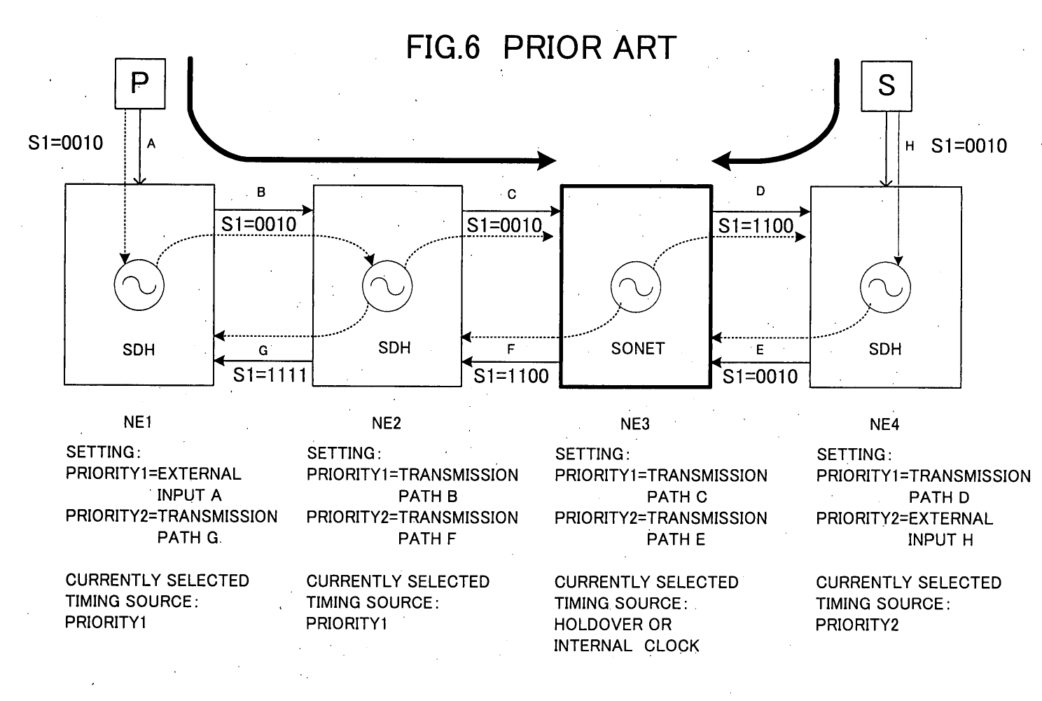

FIG. 7 shows tables ranking the quality levels of the SSM codes according to SDH and SONET;

FIG. 8 illustrates a grouping of the quality levels according to an embodiment of the present invention;

FIG. 9 illustrates a conversion operation in data transmission from a SONET apparatus via an SDH apparatus to a SONET apparatus;

FIG. 10 illustrates a conversion operation in data transmission from an SDH apparatus via a SONET apparatus to an SDH apparatus;

FIG. 11 is a schematic diagram illustrating an SSM conversion operation performed in the case where the SONET apparatus resides in the SDH network;

FIG. 12 is a schematic diagram illustrating an SSM conversion performed while the timing source is being switched due to trouble arising in a primary master clock;

FIG. 13 is a schematic diagram illustrating an SSM conversion operation performed after the timing source has been switched due to trouble arising in the primary master clock;

FIG. 14 is a block diagram showing a synchronizing unit that is implemented in a node apparatus according to a first embodiment of the present invention;

FIG. 15 is a block diagram showing a synchronizing unit that is implemented in a node apparatus according to a second embodiment of the present invention;

FIG. 16 is a block diagram showing a synchronizing unit that is implemented in a node apparatus according to a third embodiment of the present invention;

FIG. 17 is a block diagram showing a synchronizing unit that is implemented in a node apparatus according to a fourth embodiment of the present invention;

FIG. 18 is a table showing a relation between detection information and the execution of an SSM code conversion;

FIGS. 19A and 19B illustrate how a conversion table for an SDH/SONET converting unit can be arbitrarily set by a client;

FIG. 20 is a data diagram showing a structure of an S1 byte; and

FIG. 21 is a schematic diagram illustrating an SSM conversion operation performed in a case where an SDH apparatus resides in a SONET network.

### DESCRIPTION OF THE PREFERRED EMBODIMENTS

In the following, preferred embodiments of the present invention are described with reference to the accompanying drawings.

As is described above, a synchronous network cannot be established between the SDH apparatus and the SONET apparatus because SDH and SONET have different definitions for the SSM codes. If the definitions can be effectively converted, it may be possible to establish a synchronous network.

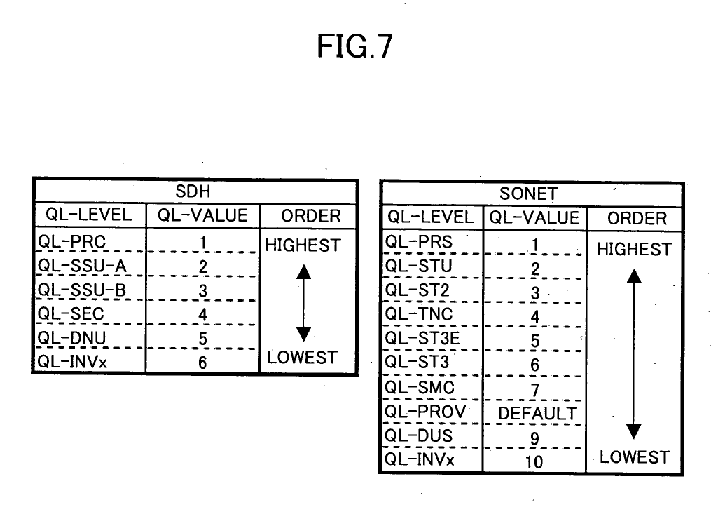

FIG. 7 shows quality rank orders of the SSM codes according to SDH and SONET that are described in the ITU-T G.781 standard. It is noted that a QL-Value corresponds to a number ranking QL-Levels within an apparatus to. facilitate handling of the QL-levels, and the higher the quality, the smaller the QL-value.

Some of the specifications of the QL-Levels assigned to the SSM codes of SDH and SONET may be identical and others may be unique. However, even the unique QL-Levels of SDH and SONET are not totally unique and are likely to have similar specifications. Thus, by inter-converting the similar significations, a synchronous system may be established with consistency.

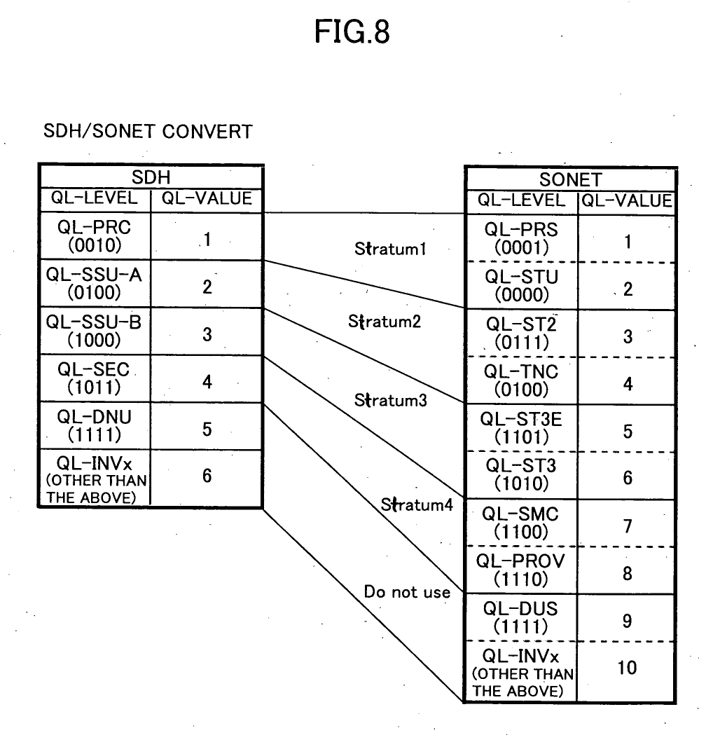

FIG. 8 shows an example of the grouping of the QL-Levels according to one embodiment. According to this drawing, the QL-Levels of SDH and SONET with similar specifications are categorized into five groups, namely, ‘Stratum 1’, ‘Stratum 2’, ‘Stratum 3’, ‘Stratum 4’, and ‘Do not Use’. Specifically, ‘QL-PRC’ of SDH, and ‘QL-PRS’ and ‘QL-STU’ of SONET belong to the group ‘Stratum 1’; ‘QL-SSU-A’ of SDH, and ‘QL-ST2’ and ‘QL-TNC’ of SONET belong to the group ‘Stratum 2’, ‘QL-SSU-B’ of SDH, and ‘QL-ST3’ and ‘QL-ST3E’ of SONET belong to the group ‘Stratum 3’; ‘QL-SEC’ of SDH and ‘QL-SMC’ and ‘QL-PROV’ of SONET belong to the group ‘Stratum 4’. Each of the nodes of a network convert the QL-Levels according to this grouping.

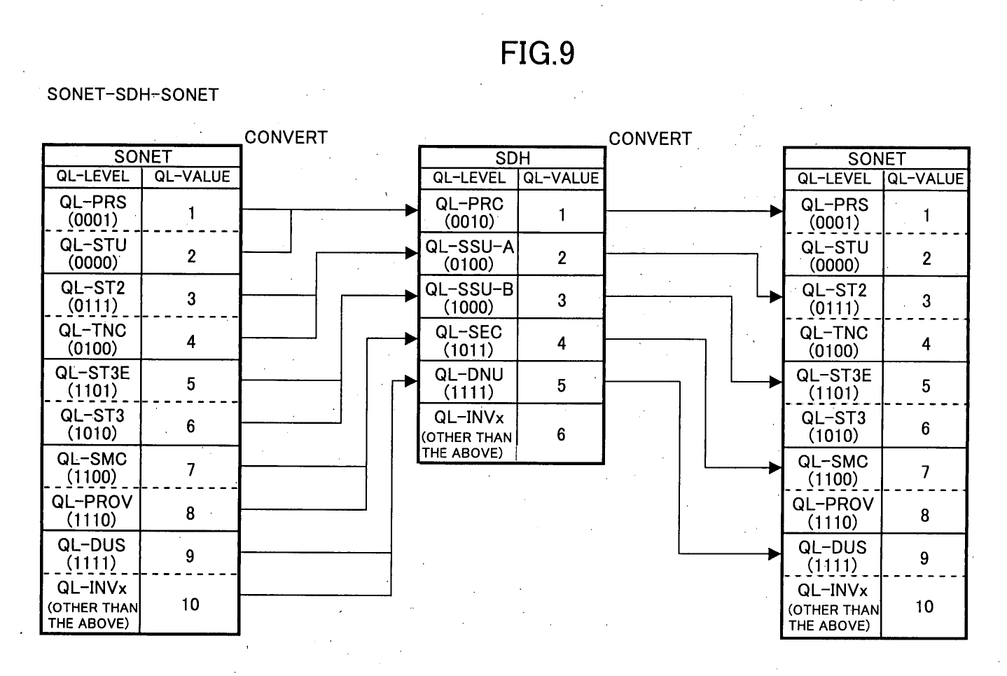

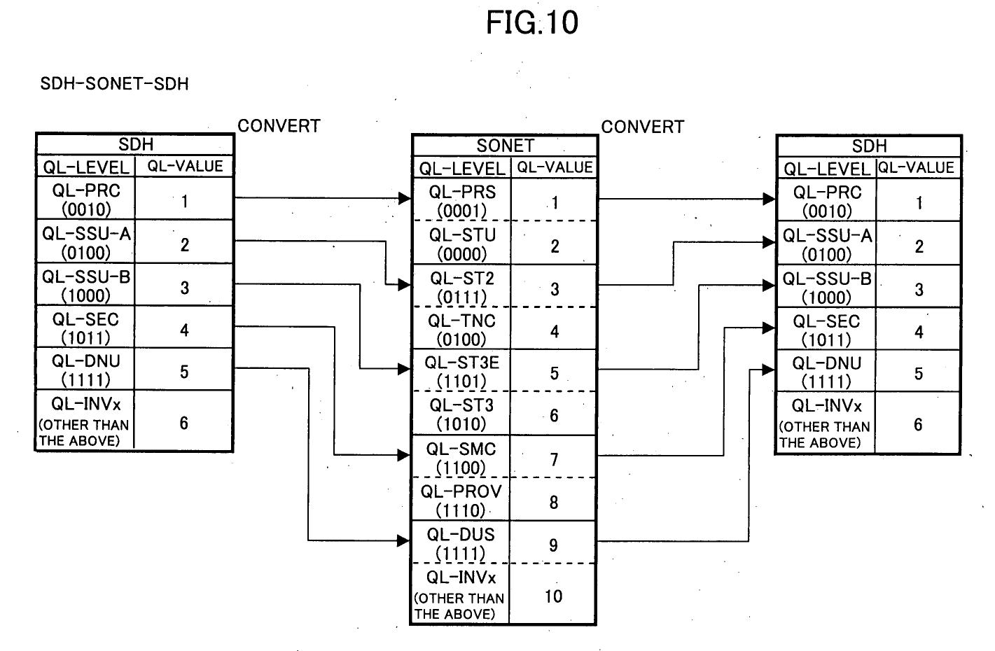

FIG. 9 illustrates a conversion operation performed in data transmission from a SONET apparatus via an SDH apparatus to another SONET apparatus (SONET-SDH-SONET); and FIG. 10 illustrates a conversion operation performed in data transmission from an SDH apparatus via a SONET apparatus to another SDH apparatus (SDH-SONET-SDH).

In the following, descriptions of how SSM codes of SDH and SONET are converted in a SDH/SONET synchronous network are given.

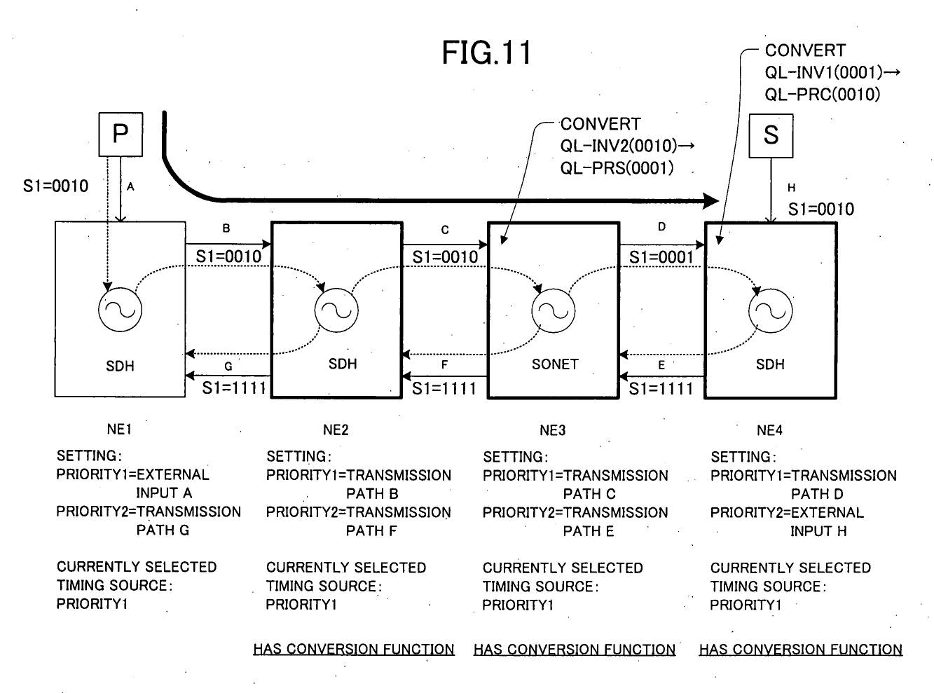

FIG. 11 is a diagram illustrating an SSM conversion operation performed in a case where a SONET apparatus (NE 3) resides in an SDH network. In this drawing, the SONET apparatus (NE 3) and its two adjacent SDH apparatuses (NE 2 and NE 4) are given SSM conversion functions.

The node NE 1 corresponding to the GNE of the synchronous system compares the SSM code=0010 (QL-PRC) from the external clock input A received from the master clock P with the SSM code=1111 (QL-DNU) received from the transmission path G, and selects the external clock input A with the higher quality as the timing source. In this case, the node NE 1 sends the SSM code=0010 (QL-PRC) corresponding to the SSM code of the timing source currently being selected to the transmission path B.

The node NE 2 compares the SSM code=0010 (QL-PRC) received from the transmission path B with the SSM code=1111 (QL-DNU) received from the transmission path F, and selects the transmission path B with the higher quality as the timing source. In this case, the node NE 2 sends the SSM code=0010 (QL-PRC) corresponding to the SSM code of the timing source currently being selected to the transmission path C, and also sends an SSM code=1111 (QL-DNU) to the transmission path G in order to prevent a timing loop.

The node NE 3 compares the value obtained from converting the SSM code=0010 (QL-INV2) received from the transmission path C into-the SSM code=0001 (QL-PRS) with the SSM code=1111 (QL-DUS) received from the transmission path E, and selects the transmission path C with the higher quality as the timing source. In this case, the node NE 3 sends the SSM code 0001 (QL-PRS) corresponding to the SSM code of the timing source currently being selected to the transmission path D, and sends the SSM code=1111 (QL-DUS) to the transmission path F in order to prevent a timing loop.

The node NE 4 compares the value obtained by converting the SSM code=0001 (QL-INV1) received from the transmission path D to the SSM code=0010 (QL-PRC) with the SSM code=0010 (QL-PRC) from the external clock input H received from the master clock S, and upon determining that the quality levels of the two SSM codes are the same, selects the transmission path D with the higher priority as the timing source. In this case, the node NE 4 sends the SSM code=1111 (QL-DUS) to the transmission path E in order to prevent a timing loop.

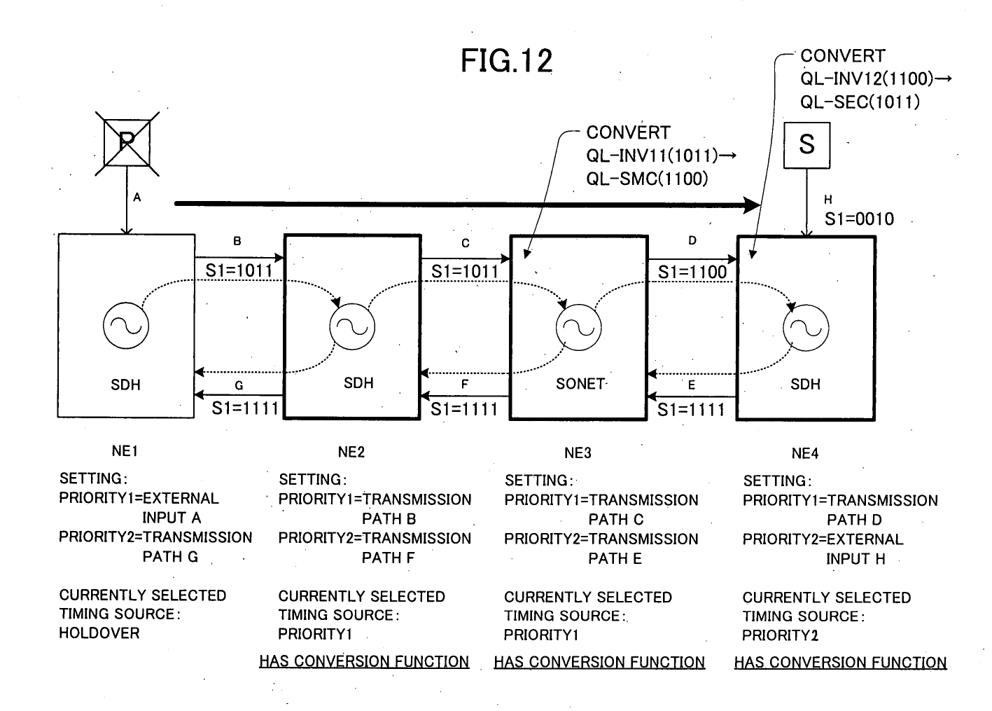

FIG. 12 is a diagram illustrating an SSM conversion in a case where trouble occurs in the master clock P and the timing source is in the process of being switched. In this drawing, the node NE. 1 compares the SSM code=1111 (QL-DNU) received from the external clock input A from the master clock P with the SSMcode=1111 (QL-DNU) received from the transmission path G, and upon recognizing that there are no timing sources available, resorts to a holdover. In this case, the node NE 1 sends the SSM code=1011 (QL-SEC) corresponding to the SSM code of the holdover to the transmission path B in order to prevent a timing loop.

The node NE 2 compares the SSM code=1011 (QL-SEC) received from the transmission path B with the SSM code=1111 (QL-DNU) received from the transmission path F, and selects the transmission path B with the higher quality as the timing source. In this case, the node NE 2 sends the SSM code=1011 (QL-SEC) corresponding to the SSM code of the timing source currently being selected to the transmission path C, and sends the SSM code=1111 (QL-DNU) to the transmission path G in order to prevent a timing loop.

The node NE 3 compares the value obtained by converting the SSM code=1011 (QL-INV11) into the SSM code=1100 (QL-SMC) with the SSMcode=1111 (QL-DUS) received from the transmission path E, and selects the transmission path C with the higher quality as the timing source. In this case, the node NE 3 sends the SSM code=1100 (QL-SMC) corresponding to the SSM code of the timing source currently being selected to the transmission path D, and sends the SSM code=1111 (QL-DUS) to the transmission path G in order to prevent a timing loop.

The node NE 4 compares the value obtained by converting the SSM code=1100 (QL-INV12) received from the transmission path D into the SSM code=1011 (QL-SEC) with the. SSM code=0010 (QL-PRC) from the external clock input H received from the master clock S, and selects the external clock input H with the higher quality as the timing source. In this case, the node NE 4 sends the SSM code=1111 (QL-DUS) to the transmission path E in order to prevent a timing loop.

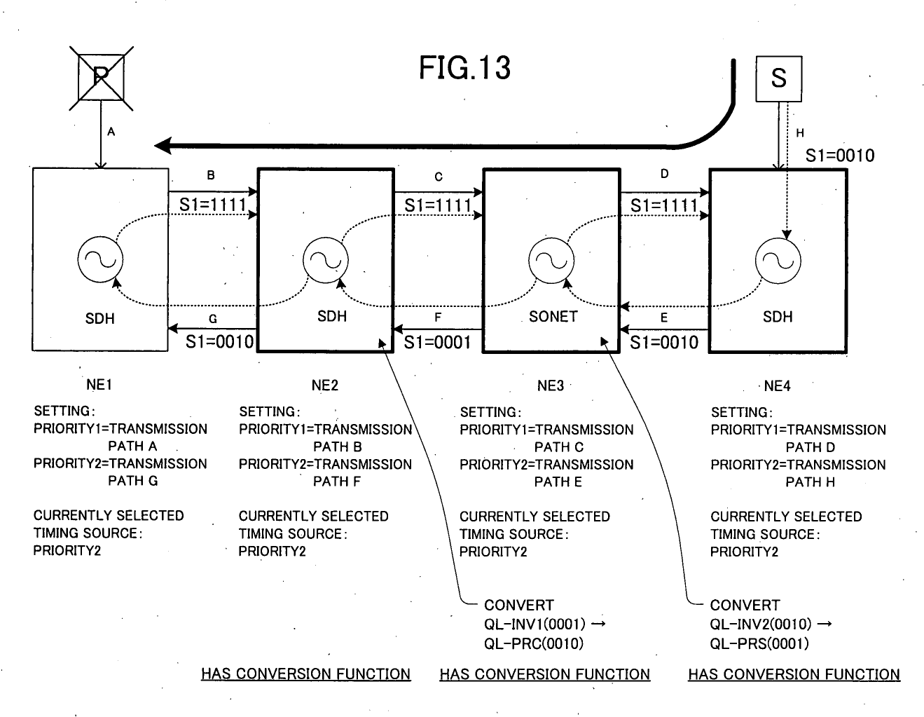

FIG. 13 is a diagram illustrating an SSM conversion performed after the timing source is switched due to trouble occurring in the master clock P. In this drawing, the node NE 4 compares the value obtained by converting the SSM code=1111 (QL-DUS) received from the transmission path D into the SSM code=1111 (QL-DNU) with the SSM code=0010 (QL-PRC) received from the master clock S, and selects the external clock input H from the master clock S as the timing source. In this case, the node NE 4 sends the SSM code=0010 (QL-PRS) corresponding to the SSM code of the timing source currently being selected to the transmission path E in order to prevent a timing loop.

The node NE 3 compares the value obtained by converting the‘SSM code=0010 (QL-INV2) received from the transmission path E into the SSM code=0001 (QL-PRS) with the SSM code=1111 (QL-DUS) received from the transmission path C, and selects the transmission path E with the higher quality as the timing source. In this case, the node NE 3 sends the SSM code=0001 (QL-PRS) corresponding to the SSM code of the timing source currently being selected to the transmission path F, and sends the SSM code=1111 (QL-DUS) to the transmission path D in order to prevent a timing loop.

The node NE 2 compares the value obtained by converting the SSM code=0001 (QL-INV1) into the SSM code=0010 (QL-PRC) with the SSMcode=1111 (QL-DNU) received from the transmission path B, and selects the transmission path F with the higher quality as the timing source. In this case, the node NE 2 sends to the transmission path G the SSM code=0010 (QL-PRC) corresponding to the SSM code of the timing source currently being selected, and sends to the transmission path C the SSM code=1111 (QL-DNU) in order to prevent a timing loop.

Next, specific descriptions of how the SSM codes are -converted within an apparatus are given.

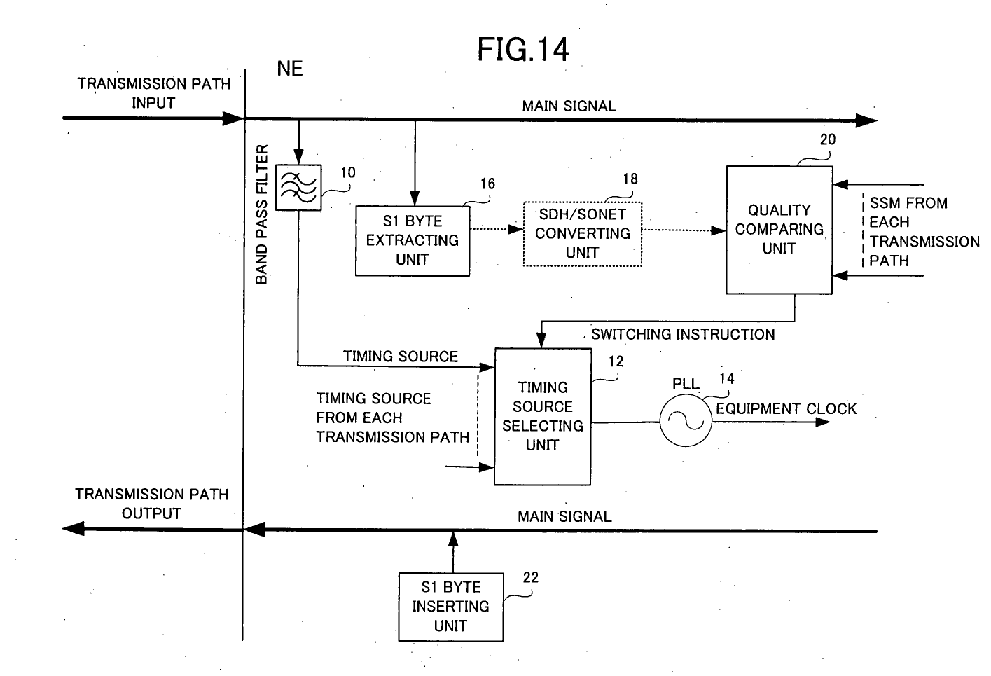

FIG. 14 is a block diagram of a synchronizing unit that is implemented in a node according to a first embodiment. In this drawing, a transmission path input is supplied to a band pass filter 10 where a clock is extracted. Then the extracted clock is supplied to a timing source selecting unit 12. The timing source selecting unit 12 receives extracted clocks from respective transmission paths and selects one of the received clocks based on a switching instruction. The timing source selecting unit 12 then supplies the selected clock to a PLL circuit 14. The PLL circuit 14 generates an apparatus clock in sync with the clock supplied thereto and supplies the generated apparatus clock to an ensuing circuit (not shown).

Also, the synchronizing unit of the present embodiment includes an S1 byte extracting unit 16 that extracts an SSM code attached to the low-order four bits of an S1 byte in a SOH (Section Over Head) of a main signal of the transmission path input(either SDH or SONET). The extracted SSM code is supplied to an SDH/SONET converting unit 18. The SDH/SONET converting unit 18 converts the SSM code from SDH to SONET or vice versa using a conversion table such as that shown in FIG. 8. In the network shown in FIG. 11, the synchronizing unit according to the present embodiment is implemented in the SONET apparatus (node NE 3) and its two adjacent SDH apparatuses (nodes NE 2 and NE 4) to realize SSM conversion. It is noted that in the node NE 1, a conventional synchronizing unit that is not equipped with the SDH/SONET converting unit 18 may be used.

The converted SSM code is supplied to a quality comparing unit 20, where the supplied SSM code is compared with at least one SSM code of a main signal supplied from another transmission path. Based on the comparison, a switching instruction for selecting the extracted clock from the transmission path with the highest quality is generated, and this switching instruction is supplied to the timing source selecting unit 12. Also, the synchronizing unit of the present embodiment includes an S1 byte inserting unit 22 that inserts an SSM code into the low-order four bits of an S1 byte in a SOH of a main signal (SDH or SONET) of a transmission path output.

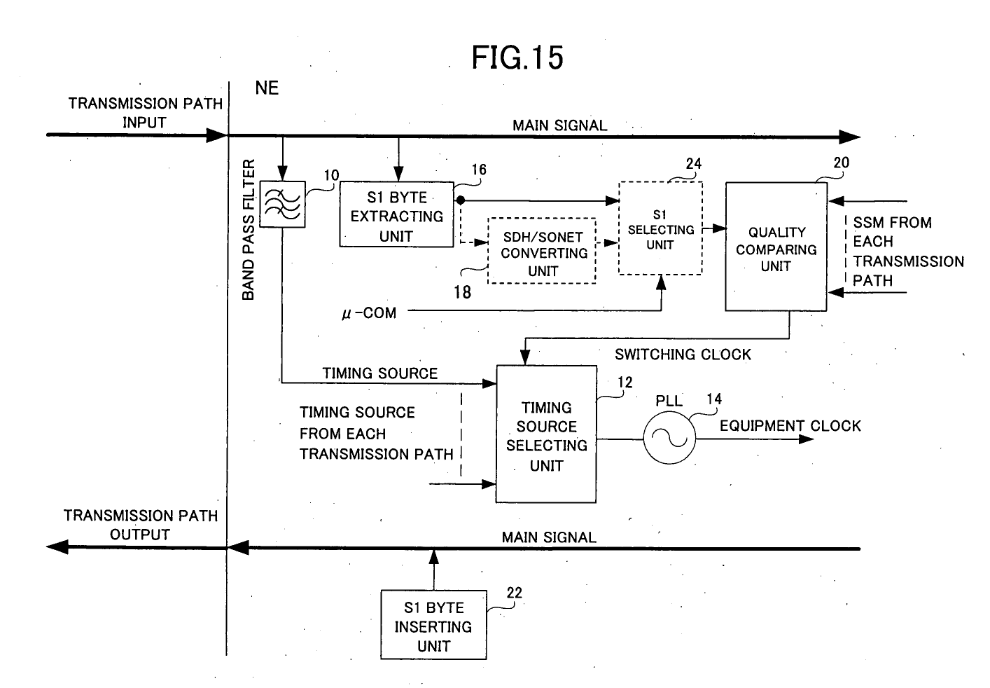

FIG. 15 is a block diagram of a synchronizing unit that is implemented in a node according to a second embodiment. In this drawing component parts that are identical to those of the first embodiment shown in FIG. 14 are given the same numerical references. In FIG. 15, a transmission path input is supplied to a band pass filter 10 where a clock is extracted. The extracted clock is then supplied to a timing source selecting unit 12. The timing source selecting unit 12 receives extracted clocks from a plurality of transmission paths and selects one of the extracted clocks based on a switching instruction. The selected clock is then supplied to a PLL circuit 14. The PLL circuit 14 generates an apparatus clock in sync with the clock supplied thereto and supplies the generated apparatus clock to an ensuing circuit (not shown).

The synchronizing unit of the present embodiment also includes an S1 byte extracting unit 16 that extracts an SSM code attached to the low-order four bits of an S1 byte in a SOH (Section Over Head) of a main signal of a transmission path input (either SDH or SONET). The extracted SSM code is supplied to an SDH/SONET converting unit 18 as well as to an S1 selecting unit 24. The SDH/SONET converting unit 18 converts the extracted SSM code from SDH to SONET or vice versa using a conversion table such as that shown in FIG. 8, and supplies the converted SSM code to the S1 selecting unit 24.

The S1 selecting unit 24 receives a switching instruction signal from a control unit μ-COM (not shown) that is implemented in the node, selects one of either the extracted SSM code or the converted SSM code based on the switching instruction signal, and supplies the selected SSM code to a quality comparing unit 20.

In the network shown in FIG. 11, the S1 selecting units 24 implemented in the SONET apparatus (node NE 3) and its two adjacent SDH apparatuses (nodes NE 2 and NE 4) select the converted SSM code, and the S1 selecting unit 24 of the node NE 1 selects the extracted SSM code. In other words, according to the present embodiment, the nodes requiring the SDH/SONET conversion function and nodes not requiring this function may have the same configuration.

The converted SSM code supplied to the quality comparing unit 20 is compared with at least one SSM code of a main signal supplied from another transmission path. Based on the comparison, a switching instruction for selecting the extracted clock from the transmission path with the highest quality is generated, and the switching instruction is supplied to the timing source selecting unit 12. Also, the S1 byte inserting unit 22 inserts the SSM code of the selected timing source in the low-order four bits of an S1 byte in the SOH of the main signal of the transmission path output (either SDH or SONET).

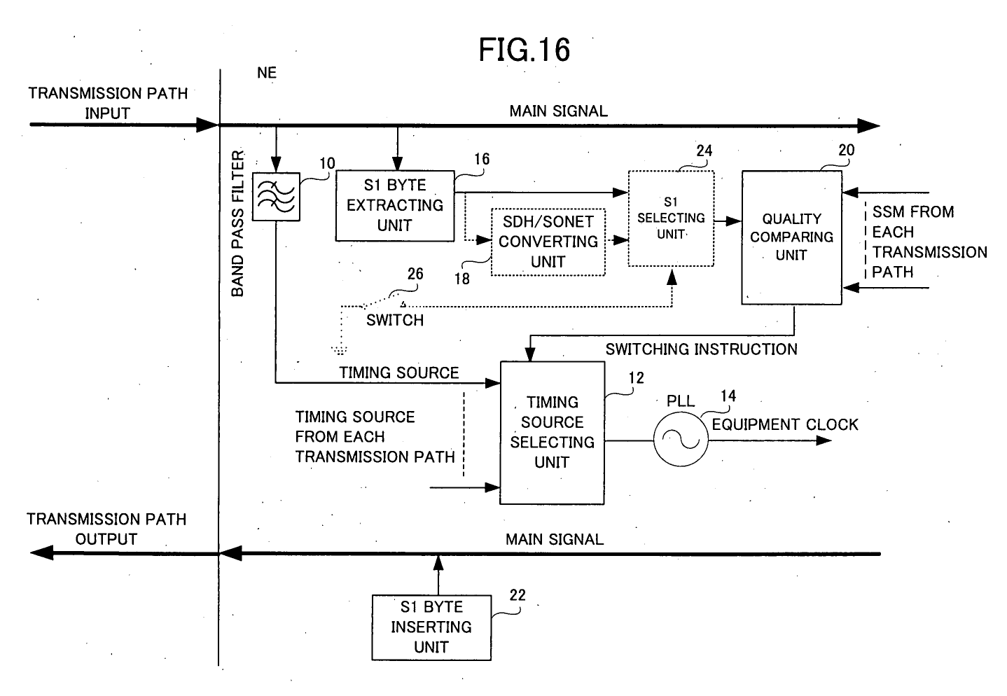

FIG. 16 is a block diagram of a synchronizing unit that is implemented in a node according to a third embodiment. In this drawing, components parts identical to those shown in FIG. 15 are given the same numerical references and their descriptions are omitted. In the present embodiment, an S1 selecting unit 24 receives an ON/OFF signal from a dip switch 26 as a switching instruction signal. According to this embodiment, the dip switch 26 is used instead of the control unit (μ-COM) so that the hassle with software debugging that takes place in the control unit (μ-COM) does not have to be dealt with. This arrangement is made in consideration of the fact that the setting of the S1 selecting unit 24 is rarely switched.

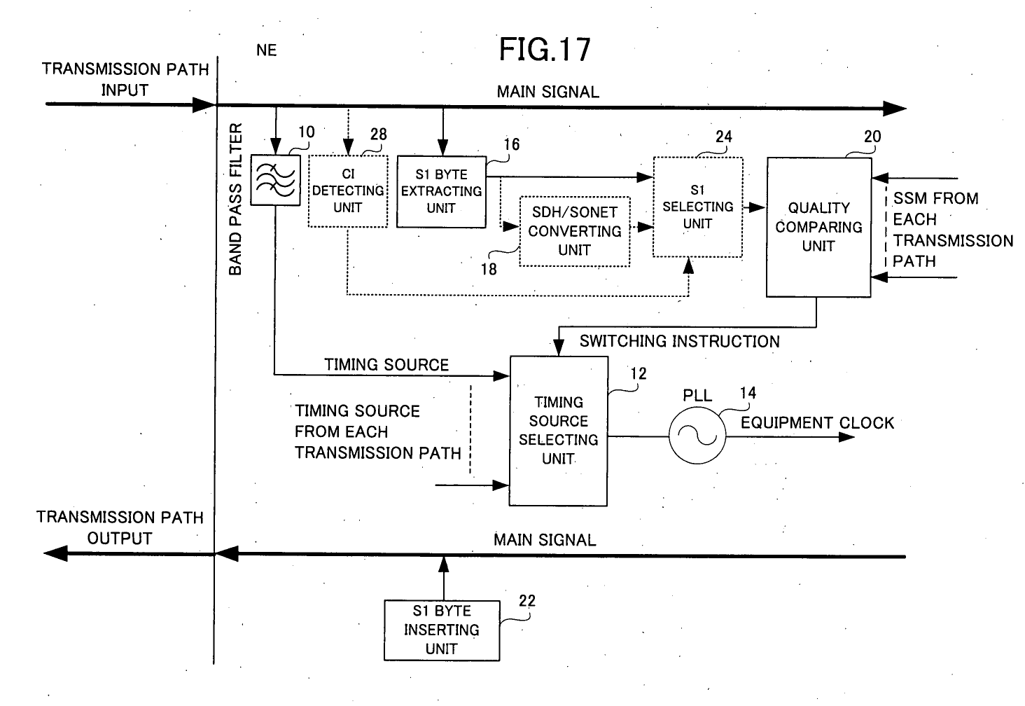

FIG. 17 is a block diagram of a synchronizing unit that is implemented in a node according to a fourth embodiment. In this drawing, the component parts that are identical to those shown in FIG. 15 are given the same numerical references and their descriptions are omitted. According to this embodiment, the distinction between SDH and SONET is automatically detected from the main signal of the transmission path input and the switching of the S1 selecting unit 24 is controlled based on this information. The detection of SDH or SONET is performed by referring to a pointer in the SOH of the main signal, namely, SDH and SONET can be easily distinguished by determining whether a CI (Concatenation Indication) is included in the pointer (H1, H2 byte) of the SOH.

In FIG. 17, a CI detecting unit 28 detects a CI in the pointer of the SOH of the transmission path input, and the S1 selecting unit 24 is controlled based on the detection information output by the CI detecting unit 28.

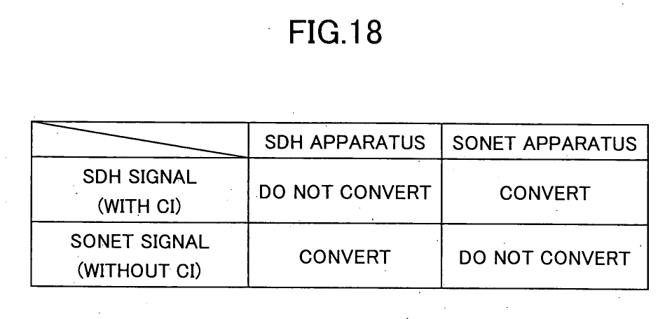

FIG. 18 is a table chart showing a relation between the detection information and the execution of the SSM conversion.

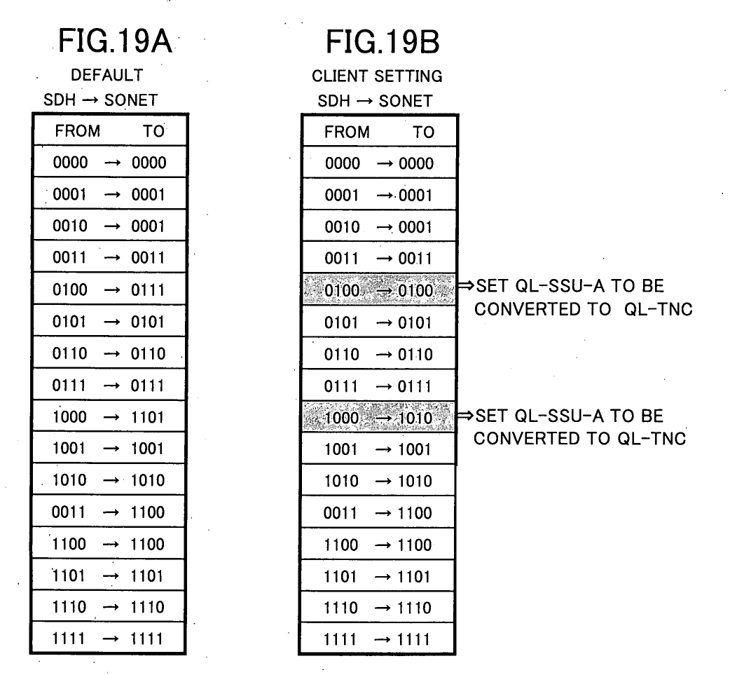

It is noted that the conversion table for the SDH/SONET converting unit 18 may be arbitrarily set by a client, that is, the client is able to create the conversion table. For example, FIG. 19A shows a default conversion table for converting SDH into SONET, and the client is able to rearrange this default conversion table to create the client's own conversion table as shown in FIG. 19B.

In the above example, according to the default conversion table, QL-SSU-A is converted into QL-ST2, and QL-SSU-B is converted into QL-ST3E; however, according to the conversion table created by the client, QL-SSU-A is converted into QL-TNC, and QL-SSU-B is converted into QL-ST3.

It is also noted that the number of SSM codes defined in SDH and the number of SSM codes defined in SONET differ. For example, there are six types of SSM codes according to SDH and ten types of SSM codes according to SONET, as shown in FIG. 8. Thus, in a case where an SSM code is converted from SONET to SDH and then back to SONET, the resulting SONET SSM code may be different from the original SONET SSM code.

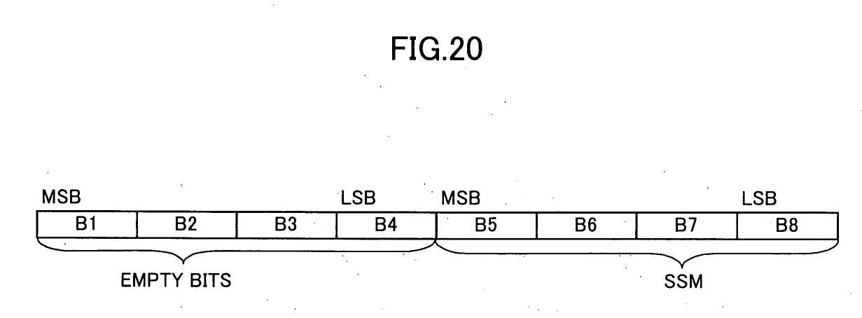

FIG. 20 shows a data-structure of the S1 byte. The S1 byte is made up of eight bits, and the SSM code is transmitted using the low-order four bits of the eight bits making up the S1 byte. The high-order four bits are empty bits, and in the present embodiment, the SSM code before conversion is included in the empty bits corresponding to the high-order four bits.

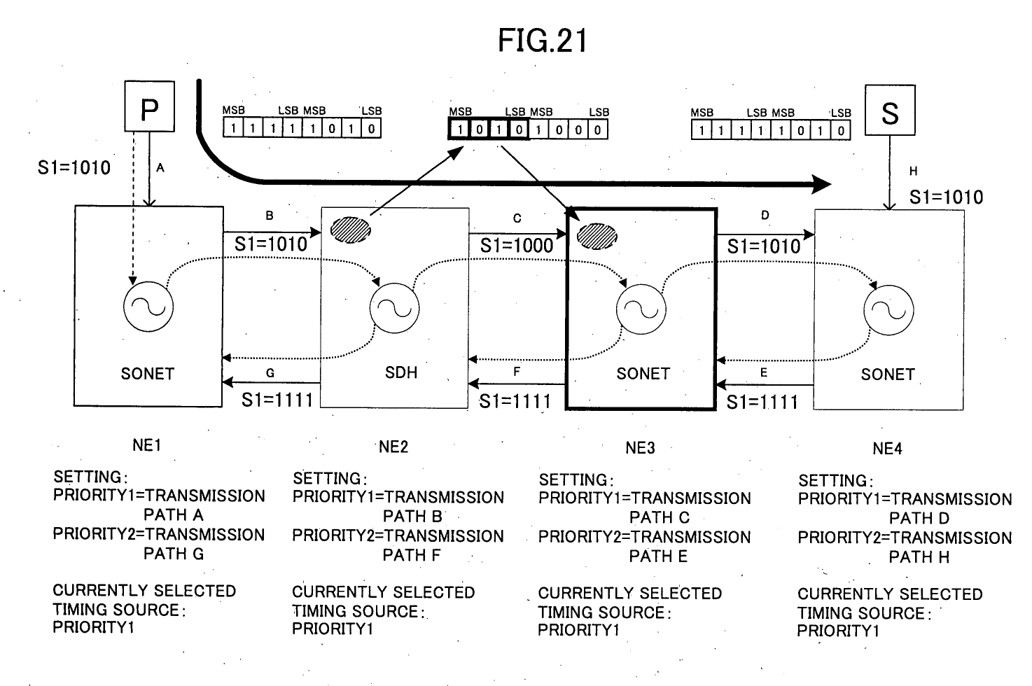

FIG. 21 is a block diagram illustrating the SSM conversion performed in a case where an SDH apparatus (NE 2) resides within a SONET network. According to the present embodiment, the SDH apparatus (NE 2) converts the low-order four bits received from one of its adjacent SONET apparatuses (NE 1 or NE 3) as an SSM code and sends to the SONET apparatus on the other side (NE 3 or NE 1) the converted SSM code using the low-order four bits while also sending the pre-converted original SSM code using the high-order four bits. In this drawing, the SDH apparatus NE 2 converts the SSM code=1010 from the SONET apparatus NE 1 into the SSM code=1000 according to the conversion table of FIG. 8, and inserts the original SSM code=1010 in the high-order four bits and the converted SSM code=1000 in the lower-order four bits of the S1 byte for transmission to the SONET apparatus NE 3.

The two SONET apparatuses (NE 1 and NE 3) adjacent to the SDH apparatus (NE 2) are arranged to process the high-order four bits transmitted thereto as the SSM code from the SDH apparatus. In this way, the SSM code of the SONET apparatus may be accurately converted even when passing through an SDH apparatus.

Accordingly, a switching of the timing source can be properly realized even between an SDH apparatus and a SONET apparatus and a synchronous network may be established in a network accommodating both the SDH apparatus and the SONET apparatus.

It is noted that the present invention is not limited to these preferred embodiments, and variations and modifications may be made without departing from the scope of the present invention.

The present application is based on and claims the benefit of the earlier-filing date of Japanese Patent Application No.2002-360827 filed on Dec. 12, 2002, the entire contents of which are hereby incorporated by reference.

What is claimed is:

1. A synchronous network establishing method of establishing a synchronous network in which a node apparatus conforming to a first scheme and a node apparatus conforming to a second scheme co-reside, wherein the first scheme and the second scheme implement different synchronous state indication codes for establishing the synchronous network, said method comprising the step of:
converting a first synchronous state indication code that is supplied from the node apparatus conforming to one of the first scheme and the second scheme into a second synchronization state indication code for the node apparatus conforming to the other one of the first scheme and the second scheme.

2. The synchronous network establishing method as claimed in claim 1, further comprising the step of:
including the first synchronous state indication code that is supplied from the node apparatus conforming to one of the first scheme and the second scheme in an empty bit of the converted second synchronous state indication code.

3. The synchronous network establishing method as claimed in claim 1, further comprising the step of:
using a pre-converted synchronous state indication code included in an empty bit of the first synchronous state indication code that is supplied from the node apparatus conforming to one of the first scheme and the second scheme.

4. A node apparatus conforming to one of a first scheme and a second scheme that is connected to a counterpart node apparatus conforming to the other one of the first scheme and the second scheme, wherein the first scheme and the second scheme implement different synchronous state indication codes for establishing a synchronous network, said node apparatus comprising:
a synchronous state indication code converting unit for converting the synchronous state indication code supplied from the counterpart node apparatus into the other synchronous state indication code for said node apparatus conforming to one of the first scheme and the second scheme.

5. The node apparatus as claimed in claim 4, further comprising:
a selecting unit for selecting one of the synchronous state indication code supplied from the counterpart node and the converted synchronous state indication code obtained by the synchronous state indication code converting unit.

6. The node apparatus as claimed in claim 5, wherein the selecting unit administers switching according to a switching instruction signal.

7. The node apparatus as claimed in claim 5, further comprising:
a switch unit for instructing a switching of the selecting unit.

8. The node apparatus as claimed in claim 5, further comprising:
a switching instruction unit for detecting a predetermined bit of a signal supplied from the counterpart node apparatus to determine which of the first scheme and the second scheme said counterpart node apparatus conforms to, and instructing a switching of the selecting unit based on the determination.

9. The node apparatus as claimed in claim 4, wherein a content to be converted by the synchronous state indication code converting unit can be arbitrarily changed.
